(19) United States
(12) Patent Application Publication
(10) Pub. No.: US 2025/0340434 A1
(43) Pub. Date: Nov. 6, 2025

(54) REACTOR FOR PARTIAL OXIDATION OF CARBONACEOUS FEEDSTOCKS

(71) Applicant: L'Air Liquide, Societe Anonyme pour l'Etude et l’Exploitation des Procedes Georges Claude, Paris (FR)

(72) Inventors: Oliver DURST, Frankfurt am Main (DE); Peter WEIGAND, Frankfurt am Main (DE); Matthias MULLER-HAGEDORN, Frankfurt (DE); Sven RITTER, Frankfurt am Main (DE); Michael KRESS, Frankfurt am Main (DE)

(21) Appl. No.: 19/197,724

(22) Filed: May 2, 2025

(30) Foreign Application Priority Data
May 2, 2024 (EP) EP24173730

(51) Int. Cl. C01B 3/24; C10J 3/48

(52) U.S. Cl. CPC C01B 3/24; C10J 3/485; C01B 2203/0255; C01B 2203/0877; C01B 2203/1235

(57) ABSTRACT

The invention relates to a reactor, in particular an entrained flow gasifier, for producing synthesis gas by partial oxidation of a carbonaceous feedstock. The reactor comprises a reaction space, a cooling space and a gas duct fluidically connecting the reaction space and the cooling space. The gas duct has a gas inlet region adjacent to the reaction space and a gas outlet region adjacent to the cooling space. The feeding of cooling medium is effected via the gas duct. According to the invention it is provided that in the flow direction of the synthesis gas to be cooled the gas duct has a first region and a second region connected thereto, wherein the first region has a constant diameter and the second region has a diverging diameter in the flow direction of the synthesis gas to be cooled.

### CROSS-REFERENCE TO RELATED APPLICATIONS

This application claims the benefit of priority under 35 U.S.C. § 119(a) and (b) to EP patent application No. 24173730.3, filed May 2, 2024, the entire contents of which are incorporated herein by reference.

### BACKGROUND

The present invention relates to a reactor for producing synthesis gas by partial oxidation of a carbonaceous feedstock. The invention especially relates to a gas duct between the reaction space and the cooling space of such a reactor. The invention especially features an improved management of the synthesis gas to be cooled during transfer from the reaction space to the cooling space.

### FIELD OF THE INVENTION

The partial oxidation of carbonaceous gaseous, liquid or solid fuels with oxygen is a process for producing synthesis gas which is commonly used on a large industrial scale. Synthesis gas is a gas mixture comprising hydrogen and at least one carbon oxide (carbon monoxide and/or carbon dioxide). In entrained flow gasification the carbonaceous feedstock, an oxidant such as oxygen and optionally a moderator (for example steam and/or carbon dioxide) is supplied to a reaction space having a burner (also referred to as a combustion space) via a feedstock feed system. The aforementioned media react with one another and form the hot raw synthesis gas. Typical reaction temperatures are 1300° C. to 1500° C. and pressures are up to 100 bar.

The cooling of the raw synthesis gas is effected downstream of the reaction in the reaction space in a second step. A distinction is in principle made between two different cooling variants depending on the process variant and feedstock. Firstly indirect heat transfer to a cooling medium in a waste heat boiler to produce steam and secondly direct heat transfer to a cooling medium using an injection cooler. The latter is also referred to as a “quench” in the industry jargon. Further purification of the cooled raw synthesis gas is generally effected by a scrubber and optionally further processing steps which follow.

### RELATED ART

In the case of a so-called immersion quench the outlet of the reaction space is typically directly connected to a gas conducting pipe immersed in the cooling medium which conducts the hot gas from the reaction space into a water reservoir where it is cooled on flowing through the water reservoir. Such systems are described in US 2010/0325957 A1, US 2013/0189165 A1, and WO 2017/102945 A1, for example.

In the case of a free quench the hot gas from the reaction space is passed via a conducting element, for example a conducting pipe, directly into the cooling space (quenching space) into which water is injected via one or more nozzles. Such systems are described in US 2007/0051043 A1 and in US 2009/0007487 A1, for example.

In the case of a quenching tube the cooling liquid is introduced at high speed via a nozzle system into the gas flow conducted in a pipe before the latter flows into the widened quench space for direct cooling with a cooling medium. Such a system is described in DD 215 326.

An essential aspect in the cooling of hot synthesis gas passed from the reaction space into the cooling space is the flow profile and consequently also the heat and mass transfer. If a recirculation flow were to occur in the case of an abrupt transition from the outlet region of the reaction space to the cooling media feed region water droplets from the multiphase region might be transported back into the hot reaction space. The “multiphase region” is to be understood as meaning the region in which the cooling medium is added. Before it is evaporated by the hot synthesis gas the cooling medium is in liquid form. If water droplets transported back contact very hot regions (for example more than 800° C.) they can bring about thermal stresses in these regions, thus leading to destruction of the employed material. The material may be for example refractory lining bricks or metallic materials suitable for high temperatures.

If cooling water that has not been specially purified, which may contain alkali metal and alkaline earth metal compounds, is used as cooling medium, boiling or evaporation residues of these metal compounds may contact the aforementioned hot surfaces. Sodium compounds for example can destroy aluminium oxide-based refractory bricks at high temperatures. Liquid droplets need not necessarily be generated by atomization of the cooling medium. Even the rapid outgassing of a cooling liquid containing dissolved gases as a result of temperature fluctuation in the cooling space may be sufficient for formation of liquid droplets. This may especially be the case when the cooling medium employed is completely or partially the scrubbing liquid from a downstream gas scrubber. The latter is saturated with the constituents of the synthesis gas.

A further possibility for primary formation of liquid droplets may further include a relatively high heat transfer from hot synthesis gas to the cooling medium in the region of addition of the cooling medium.

### SUMMARY OF THE INVENTION

It is a general object of the present invention to at least partially overcome the aforementioned disadvantages and problems of the prior art.

It is a further object of the invention in a reactor for partial oxidation of carbonaceous feedstocks to configure the transition region from the reaction space to the cooling space in such a way that return of cooling medium from the cooling space to the reaction space especially in the form of liquid droplets is avoided.

The independent claim makes a contribution to the at least partial achievement of at least one of the aforementioned objects. The dependent claims provide preferred embodiments which contribute to the at least partial achievement of at least one of the objects.

The terms “having”, “comprising” or “containing” etc. do not preclude the possible presence of further elements, ingredients etc. The indefinite article “a” does not preclude the possible presence of a plurality.

The objects of the invention are at least partially achieved by a reactor for producing synthesis gas by partial oxidation of a carbonaceous feedstock, comprising
(a) a reaction space having a burner and having a feedstock feed system for supplying the feedstock and oxidant for producing the synthesis gas in the reaction space;
(b) a cooling space comprising a synthesis gas outlet and a cooling media outlet, wherein the cooling space is configured for cooling the synthesis gas by direct cooling with a cooling medium;
(c) a gas duct fluidically connecting the reaction space and the cooling space which comprises a gas inlet region adjacent to the reaction space and a gas outlet region adjacent to the cooling space, wherein the cooling medium feed is provided in the region of the gas duct.

According to the invention it is provided that in the flow direction of the synthesis gas to be cooled the gas duct has a first region and a second region connected thereto, wherein the first region has a constant diameter and the second region has a diverging diameter in the flow direction of the synthesis gas to be cooled.

The flow of the hot synthesis gas in the gas outlet region of the reaction space which is the same as the gas inlet region of the gas duct is initially passed through a first region of the gas duct having a constant diameter. A turbulent flow profile is formed here, thus terminating recirculation zones at the end of this first region. The end of the first region in the flow direction of the synthesis gas to be cooled is followed by a second region having a diverging diameter. In this context, “diverging” is to be understood as meaning that the diameter increases, especially continuously increases, from the start of the second region in the direction of the end of the second region in the flow direction of the synthesis gas to be cooled. A suitable widening angle of the diverging second region may be determined or estimated by CFD calculations or by fluid mechanics theory for example. The spatial widening of the second region in the direction of the cooling space ensures further effective prevention of recirculation flows. The edge regions of the flow are also slowed. This is associated with low mass and heat transfer.

The respective diameter of the gas duct is especially to be understood as meaning a traversable diameter of the gas duct free from synthesis gas to be cooled. The respective diameter is thus especially proportional to the freely traversable cross section of the gas duct.

The flow of the synthesis gas in the reactor according to the invention in principle proceeds from the reaction space into the gas duct, through the gas duct and then into the cooling space. The flow direction of the synthesis gas to be cooled thus follows the spatial sequence of
reaction space,
gas inlet region of gas duct,
gas duct,
gas outlet region of gas duct and
cooling space.

The cooling medium feed is provided in the region of the gas duct. In other words the synthesis gas to be cooled is first contacted with cooling medium in the gas duct. Such a gas duct is often also referred to as a “quench pipe”.

An aperture is optionally provided in the gas outlet region of the gas duct. A spray of cooling medium is thus produced in the gas outlet region of the gas duct, thus resulting in intimate mixing of cooling medium and synthesis gas to be cooled in the cooling space of the reactor. The actual main cooling of the synthesis gas occurs subsequently in the cooling space of the reactor.

The carbonaceous feedstock, also referred to as fuel, may be a gaseous, liquid and/or solid hydrocarbon mixture. Further examples include coal, biomass or communal waste. All carbonaceous feedstocks suitable for partial oxidation to produce synthesis gas are suitable in principle.

The synthesis gas especially contains hydrogen and carbon monoxide.

The cooling medium is preferably water.

The oxidant is preferably air, oxygen-enriched air or pure oxygen. Suitable oxygen sources include an air separation plant and/or an electrolyser.

The feedstock feed system may optionally also be used to supply a moderator for controlling the exothermicity of the partial oxidation reaction. The moderator may be steam and/or carbon dioxide. Carbon dioxide may be separated from the cooled raw synthesis gas as an unwanted reaction product and recycled to the reaction space of the reactor as a moderator.

The cooling space comprises a synthesis gas outlet and a cooling media outlet. The synthesis gas outlet, also referred to as a cold gas outlet, is used to withdraw the mixture of cooled synthesis gas and evaporated cooling medium. The cooling space typically has a fill level of condensed cooling medium in its sump region. To control this fill level condensed (excess) cooling medium is continuously withdrawn from the cooling space of the reactor.

A preferred embodiment of the reactor is characterized in that the first region of the gas duct is configured as a cylindrical region and the second region of the gas duct is configured as a conically diverging region.

The gas duct thus has a round cross section at every point of the first and second region. The second region of the gas duct is especially configured to be conically diverging in the flow direction of the synthesis gas to be cooled. That is to say the diameter of the second region is smallest at the interface with the first region. The diameter of the second region especially corresponds to the diameter of the first region at this point. At the same time the diameter of the second region is greatest at the interface with the cooling space.

A preferred embodiment of the reactor is characterized in that the diverging diameter of the second region is characterized by a widening angle α, wherein the widening angle α has a magnitude of 1° to 20°, preferably a magnitude of 2° to 10°.

The widening angle describes the angle defining the deviation from a straight second region having a constant diameter. CFD calculations have revealed that the aforementioned range from 1° to 20°, preferably a range from 2° to 10°, results in an optimal reduction in the flow rate of the synthesis gas to be cooled in the edge region of the flow. This reduction results in a low thermal stress for downstream reactor regions, especially for an optional downstream flow conducting element. The interaction with a liquid film produced in the gas duct is also reduced when such a liquid film is produced using a flow conducting element in the gas duct.

A preferred embodiment of the reactor is characterized in that the first region of the gas duct has a diameter d1 and a length l1, wherein the length ratio of l1 to d1 (l1:d1) has a value of 1 to 10.

The length l1 of the first region, also referred to as the inflow region, reported as a ratio to the diameter d1 is advantageously 1-10, since a partial turbulent flow with a slower edge profile already exists and any recirculation zones from the first region terminate there.

A preferred embodiment of the reactor is characterized in that the gas duct has a third region which is arranged upstream of the first region in the flow direction of the synthesis gas to be cooled and wherein the third region has a converging diameter in the flow direction of the synthesis gas to be cooled.

To prevent the occurrence of pressure drops and to reduce inflow turbulences the transition from the reaction space into the first region of the gas duct may have a converging diameter in the flow direction of the synthesis gas to be cooled. The third region of the gas duct is especially configured as a conically convergent region. The end of the third region adjacent to the first region in the flow direction of the synthesis gas preferably has a diameter d1 which thus corresponds to the diameter d1 of the first region of the gas duct.

A preferred embodiment of the reactor is characterized in that a free end of the second region of the gas duct is connected to a metallic flow conducting element which extends within the gas duct and towards the cooling space in the flow direction of the synthesis gas to be cooled.

The presence of a flow conducting element which follows the second region of the gas duct in the flow direction of the synthesis gas effects formation of a liquid film at the wall of the gas duct, thus making it possible to achieve efficient and uniform cooling of the synthesis gas already within the gas duct. The flow conducting element may also be referred to as a flow conducting plate.

The flow conducting element is preferably cooled by the cooling medium on its reverse side.

The cooling media feed and the flow conducting element are preferably arranged such that liquid cooling medium, especially cooling water, cools the reverse side of the flow conducting element during feeding of the cooling water. This efficiently reduces the material stress on the metallic flow conducting element.

The feeding of the cooling medium to the gas duct preferably proceeds via an annular gap, wherein the annular gap is at least partially formed by the flow conducting element and a cooling media feed system of the reactor.

The cooling media feed system of the reactor comprises a nozzle, especially a quench nozzle, which injects cooling medium into the gas duct via at least one opening therein. The cooling medium initially flows through an annular gap which is at least partially formed by the flow conducting element and the cooling media feed system. The cooling media feed system includes a cooling media source which is fluidically connected to the gas duct.

In a downstream region in the direction of the gas flow the flow conducting plate may have a curvature or a bend, i.e. a change in angle relative to the wall of the gas duct. The angle is especially reduced relative to the wall of the gas duct. As a result the raw gas flow slowed in the outer region and still cooled only to a small extent contacts a water film formed on the wall of the gas duct and flowing down the inner wall of the gas duct without any flow disruption.

A preferred embodiment of the reactor is characterized in that in order to reduce its thermal load the surface of the flow conducting element is provided with a ceramic protective coating or a metallic weld cladding.

In addition to the active cooling by the cooling medium this measure further reduces the thermal stress on the flow conducting element.

A preferred embodiment of the reactor is characterized in that the wall of the second region of the gas duct is formed by a refractory material suitable for high temperatures, in particular a material based on aluminium oxide.

The reactor is preferably configured as an entrained flow gasifier.

### BRIEF DESCRIPTION OF THE FIGURES

The invention shall now be more precisely described by a working example with the aid of the drawing, the latter not being intended to limit the invention in any way. The drawing is not to scale.

In the figures:

FIG. 1 is a schematic diagram of the constituents of the reactor according to the invention that are essential to the invention.

### DETAILED DESCRIPTION OF THE INVENTION

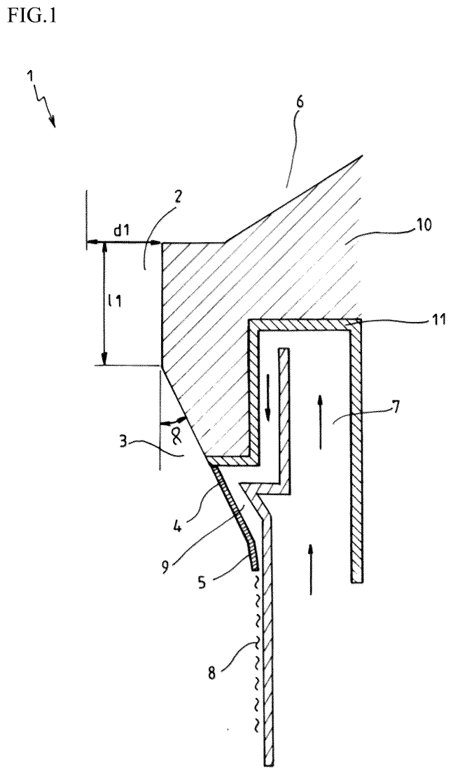

FIG. 1 shows a section of the reactor according to the invention showing especially the constituents of a gas duct 1 of a reactor according to the invention that are essential to the invention.

The reactor comprises a reaction space 6 in which synthesis gas is produced by partial oxidation of a carbonaceous feedstock. Adjacent to the reaction space 6 is the gas duct 1 which in a lower region opens into a cooling space (not shown). The lower end of the gas duct (not shown) comprises an aperture which ensures intimate mixing of the cooling medium and of the synthesis gas to be cooled. The substantial portion of the cooling of the synthesis gas occurs in the cooling space-the gas duct 1 effects essentially a precooling of the synthesis gas to be cooled.

According to FIG. 1 the synthesis gas to be cooled flows from top to bottom. That is to say that after production in reaction space 6 this passes through the gas duct 1 and is subsequently sent on to the cooling space (not shown). From the cooling space the cooled synthesis gas is withdrawn together with evaporated cooling medium, here cooling water, via a cold gas outlet (not shown) and subjected to further processing.

At the bottom of the reaction space 6 the hot synthesis gas produced in the reaction space 6 is passed into a first region 2 of the gas duct 1. To prevent the occurrence of pressure drops and to reduce inflow turbulences the transition from the reaction space 6 into the first region 2 may be conically converging. As is shown the first region 2 has a constant diameter d1 over a length l1. The diameter d1 is determined such that the flow rate of the synthesis gas to be cooled is in the range from 10 to 50 m/s. Small diameters d1 are advantageous since these reduce the length l1 of the first region. The ratio of the length l1 to the diameter d1 is advantageously 1 to 10 since this forms an at least partially turbulent flow with a slow edge profile and any recirculation zones from the upper portion of the first region 2 terminate in the lower portion of the first region 2.

Downstream thereof in the flow direction of the synthesis gas the gas duct has a conically diverging second region 3 by which the flow of the synthesis gas is widened, thus further slowing the flow in the edge region of the gas duct 1. The flow widening proceeds to such an extent that the flow of the synthesis gas does not detach from the edge region of the gas duct 1 and thus does not form a recirculation zone. The widening angle α shown may be determined by CFD calculations. The widening angle α is preferably in a range from 1° to 20°, particularly preferably in a range from 2° to 10°. Reducing the flow rate in the outer region of the gas duct achieves a lower thermal stress on a flow conducting element 4, 5 connected to the second region 3 and further downstream reduces the interaction with a liquid film 8 formed by the cooling medium.

The liquid film 8 is produced by the feed of cooling medium, also referred to as quench medium, via a cooling medium feed system 7 (quench nozzle). The flow direction of the cooling medium through the cooling medium feed system 7 is indicated by the arrows shown.

The conically diverging second region 3 of the gas duct is formed by refractory bricks of a refractory lining 10, for example based on aluminium oxide. The flow conducting element 4, 5 secured to this second region 3 extends with a similar widening angle, preferably also in the range from 1° to 20°.

The flow conducting element 4, 5 has two regions 4 and 5. These differ in their angle to the edge region of the gas duct 1, i.e. in their widening angle to the first region 2 of the gas duct. Together with the inner portion of the cooling media feed system 7 the flow conducting element 4, 5 forms an annular gap 9 which is traversed by the cooling medium and thus sufficiently cooled. This prevents corrosion processes at the metallic components of the cooling media feed system 7. A slight discontinuity necessarily exists at the transition from the second region 3 to the flow conducting element 4, 5. Locally very limited recirculation turbulences may be formed in the flow of the synthesis gas at this point. However, these do not extend to the contact point between the second region 5 of the flow conducting element and the cooling medium forming a water film 8.

The second region 5 of the flow conducting element is formed such that the synthesis gas flow slowed in the outer region of the gas duct and cooled to a small extent contacts the water film 8 flowing down the inner wall of the gas duct 1 without any flow disruption. This is realized because the widening angle of the second region 5 of the flow conducting element differs from the widening angle of the first region 4 of the flow conducting element as shown in the figure.

The cooling medium feed system 7 is configured such that the cooling medium is deflected therein. The cooling medium feed system is separated by a metallic separating element 11 from the refractory lining 10 which also forms a portion of the reaction space 6 of the reactor. The thermal stress on the refractory lining 10 is also reduced by the removal of heat by the flowing cooling medium from the cooling media feed system. The metallic separating element 11 which forms a portion of the cooling media feed system 7 also serves to connect the flow conducting element 4, 5 to the second region 3 of the gas duct. This connection may be realized by a weld connection for example.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE NUMERALS

1 Gas duct
2 First region of gas duct
3 Second region of gas duct
4 Flow conducting element (first region)
5 Flow conducting element (second region)
6 Reaction space
7 Cooling medium feed system (quench nozzle)
8 Water film
9 Annular gap
10 Refractory lining
11 Metallic separating element

1. A reactor for producing synthesis gas by partial oxidation of a carbonaceous feedstock, comprising
(a) a reaction space having a burner and having a feedstock feed system for supplying the feedstock and oxidant for producing the synthesis gas in the reaction space;
(b) a cooling space comprising a synthesis gas outlet and a cooling media outlet, wherein the cooling space is configured for cooling the synthesis gas by direct cooling with a cooling medium;
(c) a gas duct fluidically connecting the reaction space and the cooling space which comprises a gas inlet region adjacent to the reaction space and a gas outlet region adjacent to the cooling space, wherein the cooling medium feed is provided in the region of the gas duct,
wherein in the flow direction of the synthesis gas to be cooled the gas duct has a first region and a second region connected thereto, wherein the first region has a constant diameter and the second region has a diverging diameter in the flow direction of the synthesis gas to be cooled.

2. The reactor according to claim 1, wherein the first region of the gas duct is configured as a cylindrical region and the second region of the gas duct is configured as a conically diverging region.

3. The reactor according to claim 1, wherein the diverging diameter of the second region is has a widening angle α, wherein the widening angle α has a magnitude of 1° to 20°.

4. The reactor according to claim 1, wherein the first region of the gas duct has a diameter and a length l1, wherein the length ratio of l1 to d1 (l1:d1) has a value of 1 to 10.

5. The reactor according to claim 1, wherein the gas duct has a third region which is arranged upstream of the first region in the flow direction of the synthesis gas to be cooled and wherein the third region has a converging diameter in the flow direction of the synthesis gas to be cooled.

6. The reactor according claim 5, wherein the third region of the gas duct is in the form of a conically convergent region.

7. The reactor according to claim 1, wherein a free end of the second region of the gas duct is connected to a metallic flow conducting element which extends within the gas duct and towards the cooling space in the flow direction of the synthesis gas to be cooled.

8. The reactor according to claim 7, wherein the flow conducting element is cooled by the cooling medium on the reverse side.

9. The reactor according to claim 7, wherein the feeding of the cooling medium to the gas duct proceeds via an annular gap, wherein the annular gap is at least partially formed by the flow conducting element and a cooling media feed system of the reactor.

10. The reactor according to claim 1, wherein in order to reduce the thermal load the surface of the flow conducting element is provided with a ceramic protective coating or a metallic weld cladding.

11. The reactor according to claim 1, wherein the wall of the second region of the gas duct is formed by a refractory material suitable for high temperatures.

12. The reactor according to claim 1, wherein the reactor is configured as an entrained flow gasifier.
